(19) United States
(12) Patent Application Publication
(10) Pub. No.: US 2016/0281797 A1
(43) Pub. Date: Sep. 29, 2016

(54) BUCKLING SPRING MEMBER FOR CLUTCH MECHANISM

(71) Applicant: BorgWarner Inc., Auburn Hills, MI (US)

(72) Inventor: Shiwei QIN, Battle Creek, MI (US)

(21) Appl. No.: 14/442,120

(22) PCT Filed: Nov. 4, 2013
(86) PCT No.: PCT/US2013/068246

§ 371 Date: May 12, 2015

Related U.S. Application Data
(60) Provisional application No. 61/725,467, filed on Nov. 12, 2012.

(51) Int. Cl. F16D 13/58; F01P 5/12; F16D 13/30

(52) U.S. Cl. CPC F16D 13/585; F16D 13/30; F01P 5/12

(57) ABSTRACT

Buckling spring member, particularly for use with a friction clutch mechanism for dual mode water pumps. The buckling spring member is made from a thin piece of a metal material and has a circular configuration. The center portion of the spring member is concave with a plurality of openings and spokes. The openings are preferably heart-shaped. The inner and outer rings are substantially planar and provide rigidity. The friction clutch mechanism and buckling spring mechanism are preferably used for dual mode coolant pumps with two modes of operation, namely an electric motor operation and a mechanical pulley-driven operation.

### CROSS-REFERENCE TO RELATED APPLICATIONS

This application claims priority to U.S. application Ser. No. 61/725,467 filed on Nov. 12, 2012, which is related to U.S. patent application Ser. No. 61/474,907, entitled “Compression Spring Members,” filed on Apr. 13, 2011, now PCT/US2012/032876 filed on Apr. 10, 2012.

### TECHNICAL FIELD

Buckling spring members, preferably for friction clutch assemblies, are disclosed.

### BACKGROUND

Water pumps are used in water cooled engines, primarily for operation of vehicles such as automobiles and trucks with internal combustion engines. The water pumps are typically driven by a belt attached to the crankshaft of the engine and thus operate at some percentage of engine speed. The pumps have an impeller that is used to circulate the engine coolant from the engine to the radiator and back in order to keep the coolant within acceptable temperature limits.

Efforts are being made today to reduce the power consumption of engine accessories, such as water pumps, in order to improve fuel economy and reduce emissions. A unique dual mode water pump is disclosed in U.S. patent application Ser. No. 61/474,862. That device operates with less power, reduces engine load, improves fuel economy and reduces undesirable emissions.

The water pumps disclosed in Ser. No. 61/474,862, have two modes of operation, a first mode mechanical driven by the engine belt, and a second mode operated by an electric motor, such as a brushless DC (BLDC) motor. The components for the two modes of operation are contained within a housing that includes the pulley member as part of the housing. A shaft connected to the impeller of the water pump is positioned in the housing and is controlled by one mode of operation or the other, depending on certain factors.

The housing is turned at input speed by the belt of the engine positioned on the pulley member. A friction clutch mechanism is provided inside the housing to selectively allow operation of the water pump mechanically by the pulley member. A solenoid is utilized to control operation of the friction clutch mechanism. A spring member is provided which “softens” as it is displaced and minimizes the electrical power consumed by the clutch.

The water pump is normally driven by the electric motor throughout most of its range of operation. Where peak cooling requirements are needed, the mechanical mode of operation takes over and the water pump is driven directly by the pulley member. The dual mode cooling pump uses less power, improves fuel economy for the vehicle, and reduces emissions.

### SUMMARY OF THE INVENTION

An improved spring member is disclosed for a friction clutch mechanism for a dual mode water pump. The unique structure of the spring member has a region of positive stiffness and another region of negative stiffness in its performance. As the spring member is compressed, the spring force increases rapidly to its maximum. As it is further compressed, the spring force decreases almost linearly to a small value.

The spring member has a circular shape and an outer annular planar ring and an inner annular planar ring. The center area of the spring member is concave and has a plurality of openings or “windows” positioned between the inner and outer rings. The rings are flat and add stiffness and rigidity to the structure.

In a preferred embodiment, the spring member is made of a thin metal material, preferably about 0.3 mm in thickness. Due to the concave structure of the device, the height difference between the inner and outer rings in the preferred embodiment is about 2.5 mm.

The openings in the center area are preferably “heart” shaped. Six openings are preferably provided, although a different number also could be utilized. The areas between the openings are called “spokes”.

In use in a dual mode water pump, the spring member is positioned adjacent an armature plate which is selectively moved axially by a solenoid assembly. Friction lining members are connected or attached to an outer ring positioned around the spring member and attached to an armature plate. Return of the spring member to its normal shape moves the friction lining members into contact with the inside surface of the pump housing and effects mechanical operation of the pump.

Further objects, features and benefits of the invention are set forth below in the following description of the invention when viewed in combination with the drawings and claims.

### BRIEF DESCRIPTION OF THE DRAWINGS

FIG. 1 illustrates a water pump in accordance with one embodiment of the invention.

FIG. 2 is a cross-sectional view of the water pump shown in FIG. 1. FIG. 3 is an exploded view of the components of the water pump as shown in FIGS. 1 and 2.

FIG. 4 illustrates a friction clutch embodiment which can be used with a dual mode water pump.

FIG. 5 is an exploded view of the friction clutch as shown in FIG. 4.

FIG. 6 is an embodiment of a compression spring which can be used with a dual mode water pump.

FIG. 7 is a cross-sectional view of a portion of a dual mode water pump utilizing an embodiment of the present invention.

FIG. 8 is an enlarged schematic partial cross-sectional view of a portion of FIG. 7.

FIG. 9 depicts components of a solenoid assembly.

FIG. 10 is a load-deflection curve comprising spring members.

FIG. 11 depicts a preferred embodiment of the invention.

FIG. 12 is a side view of the embodiment of FIG. 11.

FIG. 13 depicts a friction clutch assembly.

FIG. 14 is a cross-sectional view of the assembly depicted in FIG. 13.

### DESCRIPTION OF THE PREFERRED EMBODIMENTS

For the purpose of promoting and understanding the principles of the present invention, reference will now be made to the embodiments illustrated in the drawings and specific language will be used to describe them. It will nevertheless be understood that no limitation as to the scope of the invention is hereby intended. The invention includes any alternatives and other modifications in the buckling spring member and friction clutch mechanism which would normally occur to persons of ordinary skill in the art to which the invention relates.

The present inventions described herein particularly relate to spring members which are selectively solenoid activated in order to change the mode of operation of a dual mode water pump. The present invention, however, can also be used in other situations and other assemblies for other products.

For purposes of describing the structure, use and operation of the inventive buckling spring member, and its improvement over the compression spring members disclosed in U.S. application Ser. No. 61/474,862, the unique and beneficial dual mode water pump assembly in that application will first be discussed.

As a coolant pump, the dual mode water pump is electrically driven under most conditions. However, it also can be mechanically engaged where more cooling is required. When the vehicle is being driven under most normal conditions, the water pump is being driven and operated by the electric motor. During “worst case” cooling conditions, such as when the vehicle is heavily loaded, when it is pulling a trailer, when it is going up hill in the summertime, etc., the water pump is adapted to be mechanically driven by the belt directly from the engine. This provides the necessary cooling under such circumstances.

In accordance with a preferred embodiment of the dual mode water pump, the electric motor is a brushless DC (BLDC) motor and the motor is positioned inside a pulley assembly. The pump is also adapted to be driven mechanically when needed by the engine belt, such as a serpentine belt, attached to the crankshaft of the engine.

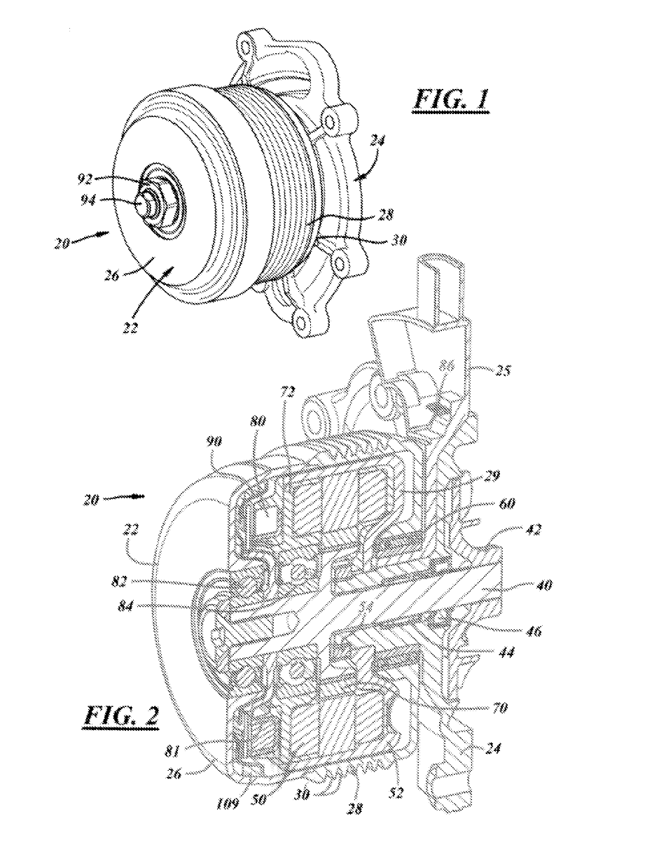

The dual mode water pump is shown in FIG. 1 and referred to generally by the reference numeral 20. The hybrid water pump includes a pulley assembly 22 and a water pump housing 24. The pulley assembly 22 has a clutch housing member 26 and a pulley member 28. The pulley member 28 has circumferential grooves 30 for being driven by a belt (not shown).

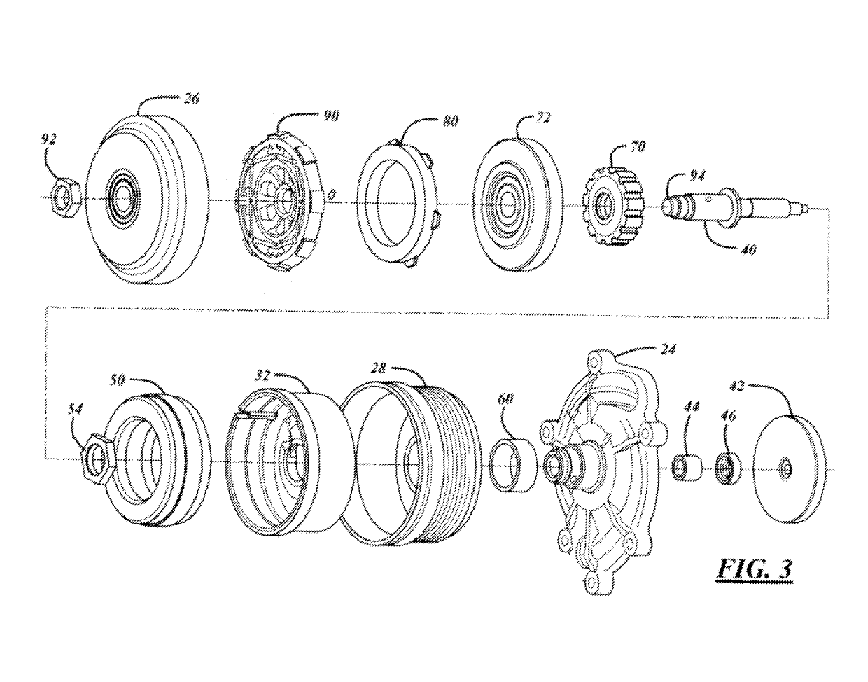

A cross-sectional view of the water pump 20 is shown in FIG. 2 and an exploded view of the components of the water pump 20 is shown in FIG. 3.

The water pump has an impeller shaft 40 which is positioned within the pulley assembly 22 and also is attached to a water pump impeller 42. The impeller shaft 40 is held in place in the pump housing 24 by needle bearing 44 and middle bearing 84. A coolant seal 46 is used to prevent coolant in the pump from leaking into the pulley assembly.

A motor stator 50 is positioned inside a stator housing 52 in the pulley assembly 22. A nut, such as a spanner nut 54, is used to hold the stator housing 52 to the pump housing 24. A second needle bearing 60 is positioned between the pulley member 28 and the pump housing 24 in order to allow the pulley assembly 22 to rotate freely relative to the pump housing.

A motor rotor 70 is positioned inside a front bearing carrier 72, which preferably is made from an aluminum material. The motor is preferably a brushless DC (BLDC) electric motor. A solenoid member 80 is positioned immediately adjacent the front bearing carrier 72. A friction clutch assembly 90 is positioned adjacent the front cover of the motor housing 22 and operated by the solenoid member 80. Bearing member 84 is positioned between the bearing carrier 72 and the impeller shaft 40.

A fastening member such as a hex nut 92 secures the pulley assembly 22 to the impeller shaft 40 via the front bearing 82. As indicated particularly in FIGS. 2 and 3, the pulley assembly 22 consists of two pieces, namely a pulley member 28 and clutch housing 26. This configuration provides for distribution of the belt load between the rear needle bearing 60 and the front ball bearing 82, thereby eliminating overhung bearing loads. Consequently, the bearing loads are minimized resulting in a more durable and long-lasting product.

As indicated, the water pump is normally driven by the electric motor. The electric motor is electrically powered through a circuit board (not shown) connected to pin-type contact members 86. Electrical leads and wires can be insert molded in housing 25 and lead frame 29 in order to carry the electrical signals to the electric motor stator 50 and solenoid 80. The circuit board further communicates with the electronic control unit (ECU) of the vehicle through the vehicle communication network such as a CAN network. The pump controller circuit board could also be positioned inside the pulley assembly 22 rearward of the stator housing 52 and having a donut shape.

The speed of the motor and thus the water pump is selected according to the cooling required for the engine. Sensors feed relevant data to the ECU which then sends a signal to the pump controller requesting the desired speed. The pump controller then determines whether the desired speed is best achieved using the electric motor or by engaging the friction clutch and driving the impeller directly from the pulley.

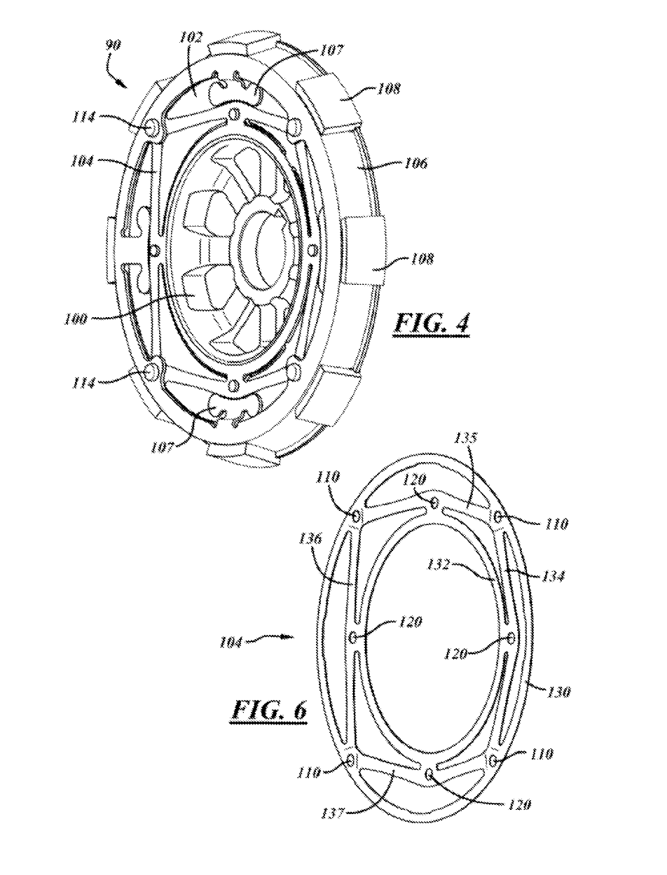

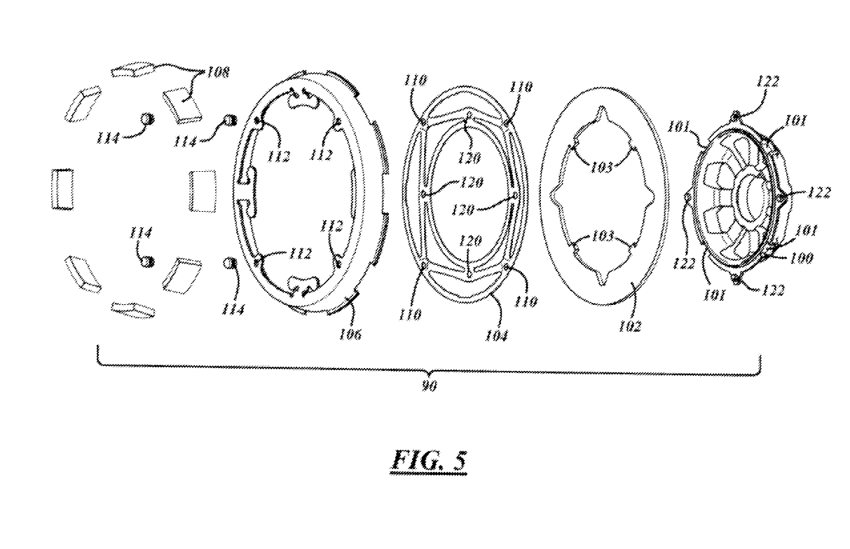

An enlarged view of the friction clutch assembly 90 is shown in FIG. 4, while an exploded view of the components of the friction clutch 90 is shown in FIG. 5. The friction clutch 90 includes a clutch carrier member 100, a flux plate member 102, a compression spring member 104, and a friction lining carrier member 106. Pieces of friction lining material 108 are attached to its outer circumference of the carrier 106, as shown in FIG. 4. The friction lining members 108 can be of any conventional friction material and can be of any size and shape. Although the friction lining material is shown with a plurality of separate members, as shown in FIGS. 4 and 5, the friction lining can be a single piece or any number of separate members positioned around the circumference of the friction lining carrier member 106.

An enlarged view of one embodiment of a compression spring member 104 is shown in FIG. 6. The spring member 104 is a “softening” spring member since the force necessary to compress it decreases as deflection increases once the deflection reaches a certain point.

The spring member 104 has a plurality of holes or openings in order to be attached to the friction lining carrier member and the clutch carrier member. In this regard, a series of four holes 110 are provided on the compression spring member 104 in order to mate with openings 112 in the friction lining carrier member 106. A plurality of rivets 114 or the like are used to secure the compression spring member 104 to the friction lining carrier member 106. The compression spring member can be joined to the friction lining carrier member by any conventional method, such as by welding, brazing, threaded fasteners, etc.

The second series of openings in the compression spring member include four openings 120. These openings mate with corresponding post members 122 on the clutch carrier member 100. The post members 122 are deformed or swaged over when the friction clutch assembly 90 is assembled in order to securely hold the components of the friction clutch assembly together. The compression spring member embodiment 104 has an outer ring member 130 and an inner ring member 132. The two ring members 130 and 132 are connected together by a plurality of connecting members 134, 135, 136 and 137.

When the friction clutch assembly 90 is in the engaged position, torque is transferred from the pulley assembly 22 through the friction lining members 108 to the friction lining carrier 106. The friction lining carrier then transfers torque through the compression spring member 104 to the clutch carrier 100 which turns the impeller shaft.

When the friction clutch assembly 90 is energized by the solenoid 80, the flux plate 102 is attracted to the solenoid assembly due to the force developed in the air gap between the solenoid core 81 and the flux plate. As the flux plate 102 moves toward the solenoid, the compression spring member 104 is compressed separating the friction lining carrier member 106 and friction members from their engaged positions against the inside surface of the clutch housing member 26. In the compressed condition, the connecting members 134, 135, 136 and 137 are buckled and distorted. In this position, the water pump is operated only by the electric motor.

The flux plate 102 is securely attached to the friction lining carrier 106 through tabs 107 (FIG. 4). Axial travel of the clutch assembly is limited by the engagement of tabs 103 on the flux plate 102 within pockets 101 on the clutch carrier member 100 (FIG. 5). This axial travel limit prevents the pole plate from coming into contact with the solenoid core member 81 as the pole plate rotates with impeller speed and the solenoid core is stationary.

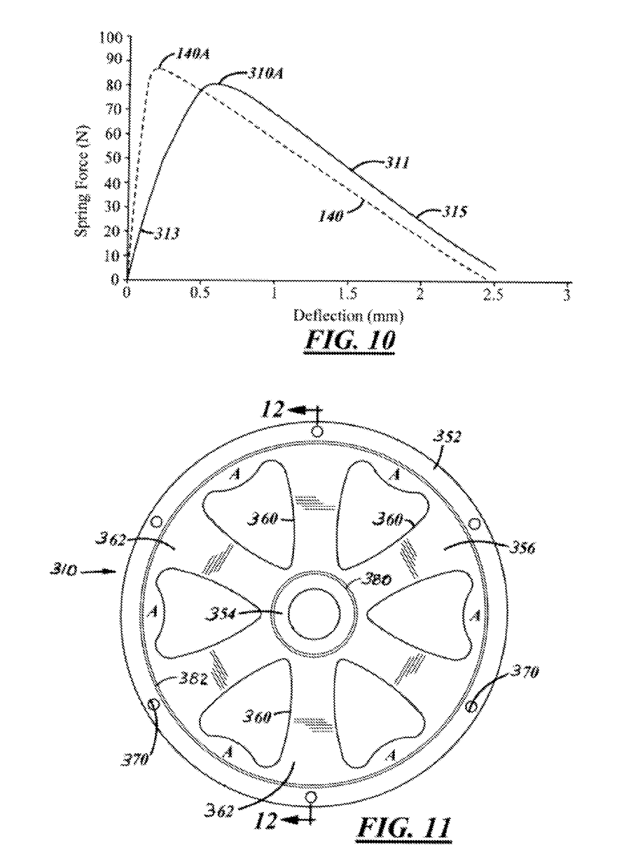

The load/deflection curves comparing the operation of the compression spring member 104 with the buckling spring member 150 discussed later is shown in FIG. 10. As shown in FIG. 10, the load/deflection curve 140 with the spring members 104 reaches quickly to a maximum amount of force 140A and then needs less force in order to continue to deflect the spring member after it is starting to deform. This means that once the compression spring has reached point 140A, less force is needed to further deflect the spring and thus prevent the friction clutch assembly from contacting the inside of the housing. Thus, once the maximum amount of force necessary to buckle or deform the spring is reached, increasingly less force is necessary in order to deflect the spring further and thus allow complete operation of the water pump by the electric motor. The softening spring member thus enables the parasitic electric power consumption of the clutch disengagement solenoid 80 to be minimized

It is common in automotive accessories such as air conditioning compressors, pumps, etc. to use spring engaged, electromagnetically disengaged clutches to selectively turn on and off the drive to the accessory component. This is typically done to conserve energy when the device is not needed. These devices are typically designed to be spring engaged so the accessory device is powered in the event of a control failure such as a loss of electrical power. This is done to provide “Fail-Safe” functionality meaning that the device defaults to its “on” state when it is unpowered.

As indicated above, the dual mode water pump provides a “fail safe” friction clutch design. If the electrical system of the vehicle were to fail, the solenoid would be de-energized allowing the spring 104 to engage the friction clutch assembly to the clutch housing. Therefore the pump would operate in mechanical mode with the impeller driven by the pulley through the clutch assembly. The clutch is thus engaged whenever circulation of coolant is needed.

The primary disadvantage of these “Fail-Safe” clutch designs is that they require continuous electrical power to keep the device disengaged when it is not needed. For many accessory devices this condition can constitute a large percentage of their operating life. Furthermore, these devices often require 20+ watts of electrical power, which can be a significant portion of the alternator output. On modern vehicles which employ a large number of electrical components (seat heaters, window defrosters, electric seats, and a host of other devices), it is not uncommon to exceed the maximum power capacity of the alternator.

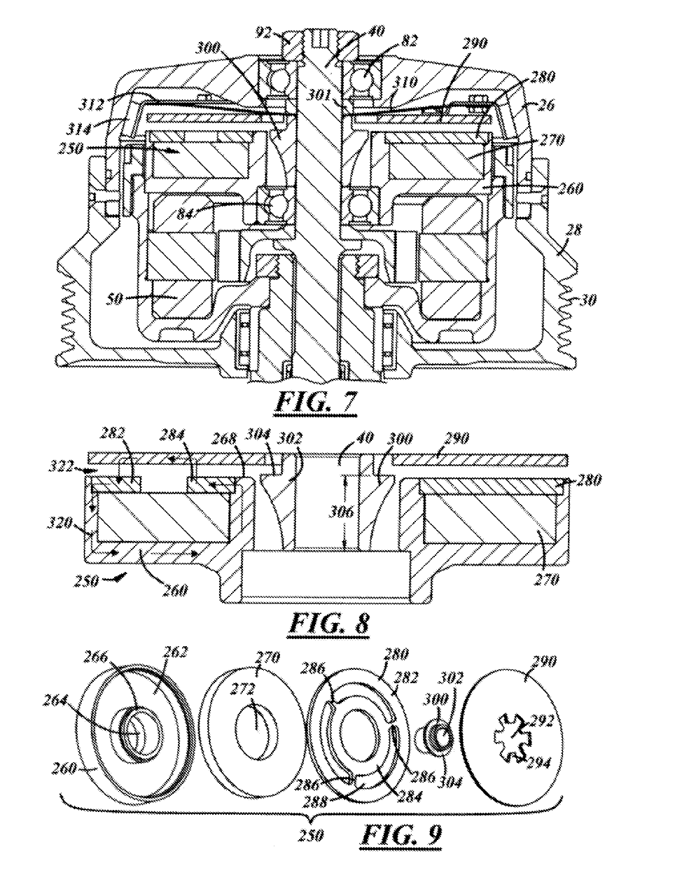

An embodiment of a solenoid assembly is shown in FIGS. 7-9. It is designed by the reference number 250. In the cross-sectional views of FIGS. 7 and 8, components of the dual mode water pump which are the same as those of the water pump described above, are referenced by the same reference numbers.

The solenoid assembly includes a solenoid core 260, a coil member 270, a flux plate member 280, an armature plate 290 and a stop member 200.

The solenoid core has basically a dish or cup-shape with a cavity 262 and preferably is made of a magnetic metal material, such as low carbon steel. The coil member is made of a coiled copper wire and has a typical “donut shape.” In the assembly, the coil member 270 is press fit or potted in the cavity 262 in the solenoid core 260 to minimize air gaps.

The flux plate member 280 has an outer ring member 282 and an inner ring member 284. The two ring members are connected by several connection members 286 (a/k/a “bridge members”). Although three connection members 286 are shown in FIG. 9, the number is not critical. There can be more or less connection members. The connection members, however, preferably are relatively narrow and spaced apart so that the outer and inner ring members are adequately separated by an insulating annular air gap 288.

The flux plate member 280 is made of a magnetic metal material, such as low carbon steel. The flux plate member 280 is pressed into the cavity 262 in the solenoid core 260 on top of the coil member 270 and preferably is positioned directly against the coil member.

The solenoid core 260 has a central opening 264 with an annular flange 266 which allows the solenoid core to be positioned around the central shaft member 40 in the dual mode water pump. The coil member 270 has a corresponding opening 272 which fits tightly around the flange 266.

The armature plate 290 is also made of a magnetic metal material, such as low carbon steel. It has a central opening 292 in order to be positioned around the shaft member 40 and stop member 300.

The stop member 300 is made of a non-magnetic material, such as aluminum or stainless steel. It has a central opening 302 in order to be positioned around the shaft member 40 and also has a ledge or shoulder member 304. The length of the body of the stop member is sized to rest against the bearing members 84 or another member which cannot move axially in the dual mode water pump. This prevents the stop member from sliding or moving axially.

As indicated in the drawings, the height 306 of the ledge or shoulder member 304 is above or greater than the height or top edge 268 of the solenoid core 260. This prevents the armature 290 from coming directly in contact with the flux plate 280 when the solenoid is activated. For this purpose, the armature plate 290 has a properly sized central opening 292, or a series of finger members 294 which allow the armature plate to contact the ledge or shoulder member 304.

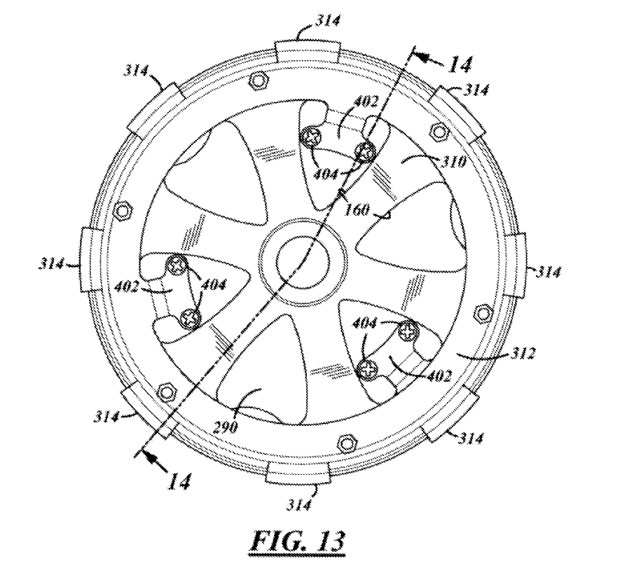

A deformable spring member 310 is positioned in contact with armature plate 290 (see FIG. 7). The outer ring of the spring member 310 is attached to an annular friction carrier member 312 which has friction members 314 positioned on it (see also FIGS. 13 and 14 as described below). The radially inner edge of the spring member 310 is fixed between stop member 300 and spacer 301 which abuts against bearing 82.

During normal operation of the dual mode water pump, the solenoid assembly is activated. The flux plate 280 which is energized by the solenoid coil 270, pulls the armature plate 290 against the ledge or shoulder on the stop member 300. This compresses and buckles the spring member 310, and prevents the friction members 314 from contacting the inside surface of the pump housing. This allows the water pump to be rotated solely by the electric motor. When it is necessary to mechanically operate the water pump (as explained above), or operate it under both of the dual modes, power to the solenoid is turned off. This allows the spring member 310 to return toward its rest condition and forces the friction members 314 into the contact with the pump housing.

The flux circuit 320 is shown in FIG. 8. The flux lines proceed from the solenoid core 260 into the inner ring member 284 where they jump through the air gap 322, pass through the armature plate 290, jump back to the outer ring member 282 of the flux plate, and finally proceed back to the solenoid core.

The flux plate 280 reduces the reluctance of the solenoid. This allows the solenoid to have more force. The flux plate also reduces the current necessary to maintain the same force.

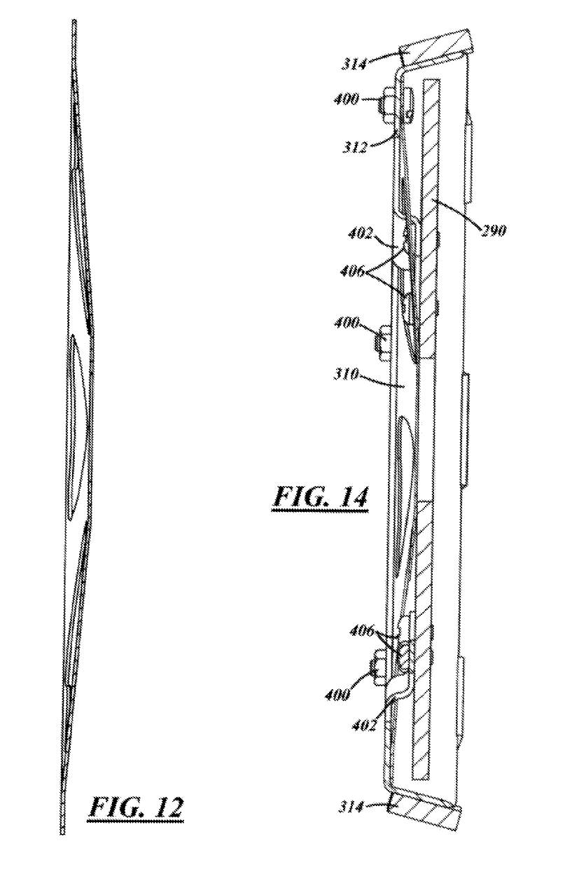

The unique buckling spring member 310 is shown in more detail in FIGS. 11 and 12. The spring member has an outer ring member 352 and an inner ring member 354 and a convex center portion 356. The inner ring member 354 is fixed to the central shaft 40.

A plurality of openings or “windows” 360 and a plurality of spoke members 362 are provided in the center portion 356. The windows 360 are preferably heart-shaped with the pointed ends of the openings adjacent the inner ring member 354. The areas marked “A” in FIG. 11 which are located generally between the radially outward facing lobes of the heart-shaped openings provide additional rigidity for the spring member 310.

Preferably six openings 360 and six spokes 362 are provided, although the number of openings and spokes could be in the range from 4 to 8. Under four spokes, the spokes could be too wide, making the spring too rigid, and over 8 spokes, the spokes could be too narrow, and not providing sufficient return biasing force, in order to effectively achieve the advantages of the invention.

A plurality of holes 370 are provided on the outer ring 352. The holes are used to mount the friction member 314, or an annular carrier member 312 with friction members on it. Such a carrier member is shown in FIGS. 13 and 14.

As indicated from FIGS. 11 and 12, the center portion 356 is concave relative to the inner and outer rings. The inner ring 354 and outer ring 352 remain substantially flat and substantially planar. In order to allow the center portion to be concave and be able to buckle and return to its normal shape, an inner circular bending groove 380 and an outer circular bending groove 382 are provided.

When the shape of the buckling spring member is formed, the inner and outer rings are clamped while a press or other fixture is used to form the concave structure of the center portion.

In a preferred embodiment, the thickness of the metal material for the spring member is about 0.3 mm. Also the distance “D” in FIG. 12 is about 2.5 mm. The metal material for the spring member 150 is preferably spring steel. These dimensions and the type of material are not critical, however, and will depend on the size and specifications of the device, as well as the designer's experience.

A load-deflection curve of the concave buckling spring member 310 is shown in FIG. 10 and designated by the reference number 311. FIG. 10 comprises the local-deflection curve of spring member 310 compared with the load-deflection curve of compression spring member 104 described above.

The buckling spring member provides the engagement force for the friction clutch in the mechanical mode of the dual mode water pump. The spring member also transfers torque. Also, as shown in FIG. 10, the unique structure of the spring member provides a region of positive stiffness 313 and a region of negative stiffness 315. The negative region is much wider than the positive region.

The structure and design of the spring member is easier to make and to hold tolerances than spring member 104. The tooling is not difficult to make and the positioning is easier during stamping. Assembly into a friction clutch mechanism is also easier and less time consuming since there are no rivets, rollover or spot welding needed.

As shown in FIG. 10, as the spring 310 is compressed, the spring force increases rapidly to its maximum 310A. As it is further compressed, the spring force drops down relatively linearly to a very small value. The total travel of the spring can be as small as 2.0 mm which can be very useful for some applications.

The unique configuration also transfers torque from the outer ring to the inner ring.

FIGS. 13 and 14 provide further details and features of the armature plate 290, friction clutch carrier member 312, and friction member 314. The friction carrier member 312 is annular in shape and is attached to the spring member 310 by a plurality of fastener members 400, such as a small bolts and nuts. A plurality of friction members 314 are positioned around the exterior of the carrier member 312. The number of friction members 312 is not critical and, although eight are shown, the number could be greater or less than eight. It is also possible that a single annular friction member could be provided (having a truncated cone shape).

The friction carrier member 312 also is attached to the armature plate member 290. A plurality of connection members 402 are provided which are secured to the armature plate 290 by fastener members 404, such as small screw members. As shown in FIG. 13, the position of the connection members 402 coincides with the heart-shaped openings 360 in the spring member 310.

Although the invention has been described with respect to preferred embodiments, it is to be also understood that it is not to be so limited since changes and modifications can be made therein which are within the full scope of this invention as detailed by the following claims.

What is claimed is:

1. A buckling spring member comprising:
an outer annual ring member, said outer ring member being substantially planar;
an inner ring member, said inner ring member being substantially planar;
a center portion having a concave configuration, said center portion having a plurality of heart-shaped openings and a corresponding number of spoke members;

2. The bucking spring member as described in claim 1 wherein the amount of force necessary to compress the spring member reaches a maximum and then lessens substantially linearly.

3. The buckling spring member as described in claim 1 wherein six heart-shaped openings are provided and six spokes are provided.

4. The buckling spring member as described in claim 1 wherein said heart-shaped opening are positioned radially with the lobes of the heart adjacent said outer ring member.

5. The buckling spring member as described in claim 1 wherein the number of openings and spokes are in the range from 4 to 8.

6. A buckling spring member for a friction clutch assembly comprising:
a friction lining carrier member;
at least one friction lining member positioned on said friction lining carrier member;
a buckling spring member fixedly attached to said friction lining carrier member;
said buckling spring member having a concave configuration and comprising a plurality of heart shaped openings therein and a plurality of spoke members extending between said openings;

7. The buckling spring member for a friction clutch assembly as described in claim 6 further comprising an armature plate member, said friction lining carrier member being attached to said armature plate member.

8. The buckling spring member as described in claim 6 wherein said spring member comprises an outer annular ring member and an inner annular spring member.

9. The buckling spring member for a friction clutch assembly as described in claim 6 wherein said friction lining carrier member is attached to said outer ring member.

10. The buckling spring member for a friction clutch assembly as described in claim 6 further comprising a solenoid mechanism for activating said friction clutch assembly.

11. The buckling spring member for a friction clutch assembly as described in claim 6 wherein the amount of force necessary to compress the convex spring member lessens over displacement once it has reached a peak amount of force.
